(19) United States
(12) Patent Application Publication
(10) Pub. No.: US 2026/0220476 A1
(43) Pub. Date: Jul. 30, 2026

(54) SYSTEMS AND METHODS FOR JOINT INTER- AND INTRA-SLICE ORCHESTRATION USING REINFORCEMENT LEARNING

(71) Applicant: Telefonaktiebolaget LM Ericsson (publ), Stockholm (SE)

(72) Inventors: Milad GANJALIZADEH, STOCKHOLM (SE); Hossein SHOKRI GHADIKOLAEI, STOCKHOLM (SE); Johan HARALDSON, STOCKHOLM (SE); Marina PETROVA, AACHEN (DE)

(73) Assignee: Telefonaktiebolaget LM Ericsson (publ), Stockholm (SE)

(21) Appl. No.: 19/146,255

(22) PCT Filed: Jan. 9, 2023
(86) PCT No.: PCT/SE2023/050016

§ 371 Date: Jul. 8, 2025

(51) Int. Cl. G06N 3/092; H04L 41/16

(52) U.S. Cl. CPC G06N 3/092; H04L 41/16

(57) ABSTRACT

A multilevel reinforcement learning (RL) system includes a first reinforcement learning orchestrator (RLO) that operates a first RL process on an environment, and a second RLO that operates a second RL process on the environment. The second RLO generates a low level (LL) action to be performed on the environment according to a LL policy based on a LL state and a LL reward that are observed from the environment. The first RLO generates a high level (HL) action to be performed on the environment according to a HL policy based on a HL state and a HL reward that are observed from the environment and based on the LL state and a plurality of LL rewards.

### TECHNICAL FIELD

The present application relates to reinforcement learning, and in particular to systems and methods for performing multilevel reinforcement learning.

### BACKGROUND

Reinforcement learning (RL) is a machine learning (ML)/artificial intelligence (AI) technique for controlling a software agent (or simply, “agent”) that operates in an environment. The agent makes observations of the environment and takes an action in the environment based on a policy which causes the state of the agent to change. The agent receives a reward based on the action, and updates the policy based on the reward and the new state. The objective of the agent is to find an optimal policy that maximizes the reward obtained from the environment.

RL assumes the underlying process that controls the state of the environment is stochastic and follows a Markov Decision Process (MDP) model. In a Markov Decision Process, it is assumed that the current state of the system depends only on the immediately preceding state and not on previous states. Often, the underlying model of a complex system is not known in advance. In that case, it is possible to use model-free RL methods, such as Q-learning, SARSA (state-action-reward-state-action), etc.

The function that describes the policy is referred to as the policy function. The function that describes the operation of the system that generates rewards is referred to as the value function. In many cases the user must specify the value function. However, computing the value function is not easy for a system with many actions and states. Instead of specifying a value function, it is possible to use deep learning methods, such as a deep neural network, to approximate the value function. This approach is known as deep RL.

In deep RL, the network takes the network states as input and outputs a value referred to as a Q-value. Based on the output Q-value for each action, the agent will select an action which generates the highest reward. The network is updated based on the expected reward and the actual reward that was obtained. The network is trained when the agent reaches a terminal state or a requisite number of episodes has been completed. This approach is sometimes referred to as a Deep Q-Network (DQN) reinforcement learning.

In a multi-agent scenario, different agents may participate together and work to refine a policy either collaboratively or competitively.

A general RL system 10 is illustrated in FIG. 1. In the RL system 10, an orchestrator 20 takes an action Aₜ on an environment 30 at a time step t. The action Aₜ is selected based on a state Sₜ of the environment at time step t along with a reward Rₜ received by the orchestrator 20 based on a previous action Aₜ₋₁. In response to the action Aₜ, a new state Sₜ₊₁ is observed, and a reward Rₜ₊₁ is generated. This action-state-reward loop is repeated until the policy function is trained.

Cyber-physical systems (CPSs) are engineered systems in which the performance of physical processes can be improved by adding computation, communications, and intelligence. Industrial CPSs may require ultra-reliable, low-latency communications (URLLC) to ensure the seamless operation of devices in the system. Failing to fulfill such demands may result in faulty or sub-optimal system behavior. In many cases, a URLLC service will work in parallel with other existing services, including distributed AI.

### SUMMARY

Some embodiments address a technical objective of using reinforcement learning in a CPS to manage the behavior of agents in an environment, where the agents operate on different time scales and have different objectives.

A multilevel RL system according to some embodiments includes a first reinforcement learning orchestrator (RLO) that operates a RL process on an environment, and a second RLO that operates a second RL process on the environment. The second RLO generates a low level (LL) action to be performed on the environment according to a LL policy based on a LL state and a LL reward that are observed from the environment. The first RLO generates a high level (HL) action to be performed on the environment according to a HL policy based on a HL state and a HL reward that are observed from the environment and based on the LL state and a plurality of LL rewards.

The first RLO receives the HL state and the HL reward and generates HL actions at a first frequency, and the second RLO receives the LL state and the LL reward and generates LL actions at a second frequency, wherein the second frequency may be different from the first frequency. The second frequency may be higher than the first frequency.

The LL action generated by the second RLO may be transmitted to an agent in the environment that may be to perform the LL action, and wherein operation of the agent in the environment may be affected by the HL action generated by the first RLO.

The agent may include a network device in a wireless communication network, and the environment may include the wireless communication network.

The HL policy may include a policy for allocating resources to a plurality of network slices in a wireless communication system, and wherein the LL policy may include a policy for selecting network devices for performing a distributed computing function, wherein the network devices utilize services of one of the plurality of network slices.

The HL action may include a selection of network resources to be allocated to the plurality of network slices. The LL action may include a selection of network devices to participate in the distributed computing function. The one of the plurality of network slices utilized by the network devices may support ultra-reliable low latency communications (URLLC).

The HL reward may be based on one or more quality of service, QoS, variables associated with the plurality of network slices, and the LL reward may be based on a convergence time of distributed learning and accuracy of the distributed computing function.

The first RLO may have a goal of maximizing a goal function that measures performance of all of the plurality of network slices.

The goal function may have the form:

$${g}_{κ} := {\sum }_{v = 1}^{V} {ζ}_{v} {r}^{v} {Ω}_{κ}^{v} ( P ) , \qquad ∀ v ∈ V$$

where V is a number of network slices, ζᵥ may be a weight characterizing a relative importance of a network slice v, r^{v} is a high-level reward for network slice v, Ω^{v}ₖ(P) is a function representing a ratio of resources allocated to network slice v according to a resource allocation matrix P.

The high-level reward for the network slice used by the network devices that perform the distributed computing function during a training epoch of the first RLO may be calculated based on a plurality of low-level rewards received by the second RLO during the training epoch.

The high-level reward for the network slice used by the network devices that perform the distributed computing function during the training epoch may be calculated as a function of the low-level rewards received by the second RLO during the training epoch.

The high-level reward for the network slice used by the network devices that perform the distributed computing function during the training epoch may be calculated as an average of the low-level rewards received by the second RLO during the training epoch.

The distributed computing function may include a distributed machine learning function.

A computer-implemented method of performing multilevel reinforcement learning according to some embodiments includes operating a first RL process on an environment by iteratively taking a HL action on the environment and, in response to the HL action, observing a HL state of the environment and receiving a HL reward, and operating a second RL process on the environment by iteratively taking a LL action on the environment and, in response to the LL action, observing a LL state of the environment and receiving a LL reward, wherein the LL state is affected by the HL action. Operating the second RL process includes generating the LL action to be performed on the environment according to a LL policy based on the LL state and the LL reward, and operating the first RL process includes generating the HL action to be performed on the environment according to a HL policy based on the HL state and the HL reward and based on the LL state and a plurality of LL rewards.

Some embodiments provide a reinforcement learning orchestrator configured to perform operations including operating a first RL process on an environment by iteratively taking a HL action on the environment and, in response to the HL action, observing a HL state of the environment and receiving a HL reward, and operating a second RL process on the environment by iteratively taking a LL action on the environment and, in response to the LL action, observing a LL state of the environment and receiving a LL reward, wherein the LL state is affected by the HL action. Operating the second RL process includes generating the LL action to be performed on the environment according to a LL policy based on the LL state and the LL reward, and operating the first RL process includes generating the HL action to be performed on the environment according to a HL policy based on the HL state and the HL reward and based on the LL state and a plurality of LL rewards.

A reinforcement learning orchestrator includes a processor and a memory. The memory comprises computer readable program instructions that, when executed by the processor, cause the reinforcement learning orchestrator to perform operations of operating a first RL process on an environment by iteratively taking a HL action on the environment and, in response to the HL action, observing a HL state of the environment and receiving a HL reward, and operating a second RL process on the environment by iteratively taking a LL action on the environment and, in response to the LL action, observing a LL state of the environment and receiving a LL reward, wherein the LL state is affected by the HL action. Operating the second RL process includes generating the LL action to be performed on the environment according to a LL policy based on the LL state and the LL reward, and operating the first RL process includes generating the HL action to be performed on the environment according to a HL policy based on the HL state and the HL reward and based on the LL state and a plurality of LL rewards.

Embodiments described herein may provide certain technical advantages. For example, a system/method as described herein may perform near real-time control for low level tasks (such as user selection) and non-real time control of higher level tasks, such as slice management of AI and URLLC slices.

Conventional horizontal solutions train all the decision variables using long time scale, which results in a long training time, and may lead to much higher energy consumption and network overhead due to excessive processing and communication. In contrast, a multilevel RL system/method as described herein may use different time scales at different levels.

### BRIEF DESCRIPTION OF THE DRAWINGS

FIG. 1 illustrates a general reinforcement learning system.

FIG. 2 illustrates a multilevel reinforcement learning system according to some embodiments.

FIG. 3 illustrates a network system in which a multilevel reinforcement learning system according to some embodiments may be used.

FIG. 4 illustrates a multi-agent reinforcement learning system according to some embodiments that is deployed in a wireless communication system.

FIG. 5 illustrates functional components of a multi-agent reinforcement learning system according to some embodiments.

FIGS. 6 and 7 illustrate operations of a multi-agent reinforcement learning system according to some embodiments.

FIG. 8A illustrates a reinforcement learning orchestrator in a multi-agent reinforcement learning system according to some embodiments.

FIG. 8B illustrates functional modules in a memory of a reinforcement learning orchestrator according to some embodiments.

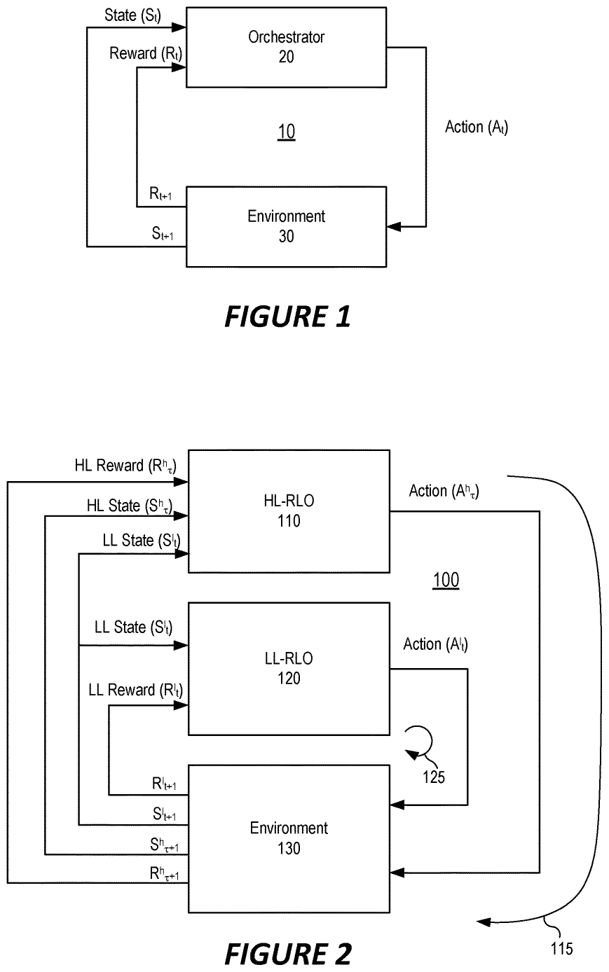

### DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As noted above, in an industrial setting, a URLLC service may work in parallel with other services, including distributed AI. For example, the environment in which the URLLC service may operate may include a manufacturing floor including numerous machines that communicate using URLLC, as well as devices that participate in distributed learning for AI. The operation of these services can be optimized by tuning their parameters and decision variables. However, in many use cases, it may be difficult to tune all such variables at the same time due to hardware or protocol constraints. In some cases, hierarchical reinforcement learning (HRL) may be used to optimize the operation of the services, as discussed in more detail below.

In an example scenario, there are URLLC and distributed AI services operating in an industrial deployment, where URLLC devices are serving a cyber-physical control application. For the URLLC service, an industrial automation scenario is assumed in which a set of [symbol] :={1, 2, . . . , B} gNodeBs (gNBs) serve a set of [symbol] :={1, 2, 3, . . . , U}, industrial devices in the deployment.

Reliability key performance indicators (KPIs) for the URLLC service may be calculated based on an application state variable for ith device, uᵢ:

$${Z}_{i} ( t ) = \{ \begin{matrix}0 , & if application is in failed state \\ 1 , & otherwise .\end{matrix} for ∀ i ∈ 𝒰 \qquad ( 1 )$$

Note that the application can tolerate failures shorter than survival time, defined per use case. Hence, Zᵢ(t) remains 1, if the failures on the network are shorter than survival time.

Communication service availability (αᵢ) is defined as the percentage of time during which the end-to-end communication service is delivered according to an agreed quality of service (QoS) of the application it serves, divided by the amount of time the system is expected to deliver the end-to-end service according to the specification of the target application layer in a specific area.

The communication service is considered unavailable if it does not meet the pertinent QoS requirements. For example, the communication service is considered to be unavailable if a message is not correctly received within a specified time, which is the sum of maximum allowed end-to-end latency and the survival time of the application layer. The communications service availability for user i may be expressed as:

$${α}_{i} := {lim}_{t \to ∞} P r \{ {Z}_{i} ( t ) = 1 \} = {lim}_{T \to ∞} \frac{1}{T} {\int }_{t = 0}^{T} {Z}_{i} ( t ) dt \qquad ( 2 )$$

Communication service reliability (τᵢ) is defined as the mean duration of time that the application is operational (i.e., Zᵢ(t)=1). Let Yᵢ(t) denote the number of times the crossing from Zᵢ(t)=1 to Zᵢ(t)=0 occurs. Then, the reliability of device uᵢ can be defined as:

$${τ}_{i} := {lim}_{T \to ∞} \frac{1}{{ϒ}_{i} ( t )} {\int }_{r = 0}^{T} {Z}_{i} ( t ) dt \qquad ( 3 )$$

In operational technology, the communication service reliability is often referred to as the mean time between failures (MTBF). However, this metric may be misleading in the context of telecommunications, especially when the target reliability values are expressed in long periods of time, e.g., years.

Some embodiments described herein relate to distributed AI, reliable communications, and slicing. Each of these areas is discussed below.

### Communication-Efficient Distributed Training

Distributed training is the cornerstone of recent advancements in AI. In most distributed training algorithms (including federated learning or split learning), a set of devices upload their local parameters to an orchestrating server (or a set of servers) that maintains a global parameter. In the first step, the devices can also share gradients.

In the following discussion, distributed training involves parameter uploads from network devices to a server. Once the server updates the global parameter, it shares that with the devices in a downlink channel. In such a scenario, uplink messages are often redundant, carrying almost no additional information since they can be retrieved from the past communicated messages of the same device as well as messages of other devices. Forcing some of the devices to remain silent may lead to 1) reduced network congestion, 2) increased throughput, 3) improved latency, and/or 4) energy savings.

Some approaches use a filter to eliminate unnecessary communications. However, such approaches may not consider any parameters of wireless channel or networking KPI in their design and, therefore, may not be optimal to regulate the coexistence of distributed training service and a URLLC service. Some approaches may leverage reinforcement learning to minimize the convergence time of federated learning (as a distributed AI algorithm) running on a wireless network. However, such approaches may not address the coexistence of distributed AI algorithms running simultaneously with other communication services.

### URLLC Service and Slicing

Due to interference, vibration, and the presence of metallic objects in the environment which may cause shadowing and/or scattering of wireless signals, the support of real-time control via wireless communication in a production environment is a challenging task.

The key URLLC performance KPIs (i.e., communications service availability and reliability) are a function of resources that are allocated to the URLLC slice. In embodiments described herein, bandwidth, transmit power and processing capability are considered as the main network resources. However, other network resources can be added as an trivial extension to this set of controlled resources. Higher resources to the URLLC slice makes it easier for the underlying communication service to meet its communication service reliability requirements. In particular, increasing the transmission power may improve the signal-to-interference plus noise ratio (SINR), hence, packet reception reliability.

Moreover, higher transmission power enables the gNB scheduler to use a higher code rate, which results in fewer resource blocks to deliver the same message, resulting in lower latency for packet transmission. Moreover, the available bandwidth has a significant role in the QoS level of the URLLC users. Similarly, increasing the power and/or bandwidth allocation of the distributed training service would improve its KPIs, including a faster convergence.

However, due to the limited amount of resources to be shared between URLLC and distributed training services, a proper slicing approach must be taken. In many applications, limitations on hardware or software or protocol may not allow for optimizing all the decision variables together. In some scenarios, such as telecommunication use cases, it may not be possible to change the bandwidth allocated to a particular slice during the operational phase and/or on the same time scale as other parameters. This could be due to protocol limitations since changing bandwidth, processing capabilities, or slice allocation may happen at the core network after receiving data from many base stations (gNBs), while per-gNB decisions can happen locally. In this case, previous approaches may either not be applicable or may require excessively large amounts of memory, processing power, and/or communication overhead.

### Hierarchical Reinforcement Learning

In HRL, the decisionmaker takes decisions in a hierarchy, some at higher levels (to set general goals or adjust main parameters) and some others at a lower level (to tune the network performance in shorter time horizons while navigating through the goals set by the high-level decisions). This setup is more efficient than traditional RL (also called flat RL) in which all decisions will be taken at the same time, and there is only one goal for the system, compared to HRL in which the HL policies will define some sub-goals to narrow down the problem dimension and enable more efficient solutions. A classic example is navigating through a maze in a multi-room setting where the start and end points are located in different rooms. Flat RL does not consider a multi-room structure, whereas the HRL defines subgoals (HL policies) to exit from each room, and within that subgoal uses a flat RL on LL policies to realize the subgoal. Now this subproblem is much easier to solve than the original maze problem due to its smaller state space.

Traditional flat RL solutions train all decision variables on the same timescale. However, in many telecommunication scenarios, it is desirable for the variables to be optimized on different time frames. For example, adaptive modulation and coding or beamforming may be changed for every time slot, while routing decisions or base station association variables may remain the same for many time slots. Forcing the variables to be optimized in every time slot would unnecessarily complicate the decision space and may increase energy consumption, processing, and/or communications overhead requirements.

Hierarchical reinforcement learning (HRL) can address this issue by optimizing decision variables on different time scales. Some attempts have been made to use HRL to optimize the coexistence of mobile broadband and URLLC services. However, there are two main fundamental differences between distributed AI services and other traditional communication traffic (e.g., enhanced mobile broadband (eMBB) or massive machine type communications (mMTC)). First, the performance of these conventional services is characterized by the statistics of a communication metric (e.g., throughput or energy consumption for eMBB and mMTC, respectively). Nevertheless, distributed training service is an iterative and collaborative task aiming to solve an optimization problem as quickly as possible. Hence, the performance may not be affected only by the transmission characteristics of a single device. The potential statistical correlation of data from various devices allows distributed learning to operate using a carefully chosen subset of devices. Second, in addition to well-known decision parameters for other communication services, distributed AI has a unique set of decision variables such as the model size, choice of algorithm, and selection of devices participating in the training task. Therefore, previous solutions may not be applicable to the coexistence of distributed AI and URLLC.

Some embodiments described herein provide a multilevel RL system that orchestrates both management of network slicing for URLLC and distributed AI services (as high-level decision variables) as a high level RL system as well as device selection for distributed training (as a low-level decision variable). A multilevel RL system 100 is schematically illustrated in FIG. 2. As shown in FIG. 2, the multilevel RL system 100 includes a high level RL orchestrator (HL-RLO) 110 and a low level RL orchestrator (LL-RLO) 120 that take actions A^{h}ₜ, A^{l}ₜ on an environment 130 based on a respective policy (π^{h}, π^{l}) and a state S^{h}ₜ, S^{l}ₜ of the environment 130. In response to taking the action, the HL-RLO 110 receives a reward R^{h}ₜ, while the LL-RLO receives a reward R^{l}ₜ. The action Alt of the LL-RLO 120 is determined by the low-level state S^{l}ₜ and low-level reward R^{l}ₜ. However, the action A^{h}ₜ of the HL-RLO 110 is determined by the low-level state S^{l}ₜ in addition to the high-level state S^{h}ₜ and the high-level reward R^{h}ₜ.

As shown in FIG. 2, the LL-RLO 120 operates in a low-level (LL) loop 125, while the HL-RLO 110 operates in a high-level (HL) loop 115 that encompasses the LL loop 125.

Note that the HL-RLO 110 and LL-RLO operate with different time steps, namely tau (τ) for the HL-RLO 110 and t for the LL-RLO 120. As described in more detail below, the HL-RLO 110 and the LL-RLO 120 may operate with different time steps, as the HL-RLO 110 and the LL-RLO 120 may be able to take actions on the environment 130 and collect rewards from the environment 130 with different frequencies. For example, the HL-RLO 110 may be able to take actions on the environment 130 and collect rewards relatively slowly, while the LL-RLO 120 may be able to take actions on the environment 130 and collect rewards quickly relative to the HL-RLO 110. Thus, in some embodiments the time step t of the HL-RLO 110 is larger than the time step t of the LL-RLO 120. In some cases, either the time step t or the time step τ may be variable.

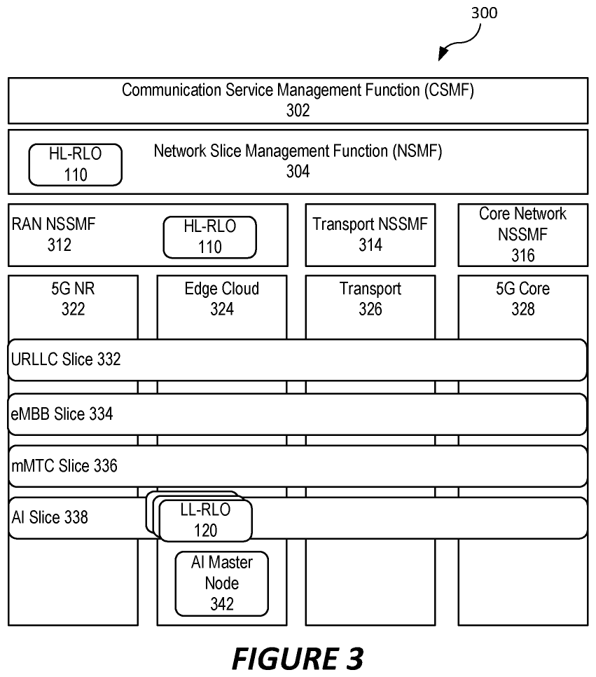

In an example embodiment, a wireless communication system that supports network slicing is considered. In the example, one network slice is dedicated to providing URLLC communication services to devices, while another network slice is dedicated to training an AI model using a distributed training algorithm that uses network devices (which may or may not include URLLC devices) to perform parts of the training. The example scenario is illustrated in FIG. 3, which illustrates a functional arrangement of various portions of a wireless communication system 300. In particular, the wireless communication system includes various domains, including a radio access network (RAN) 322, such as a 5G New Radio (NR) RAN, an edge cloud 324, a backbone transport network 326, and a core network (CN) 328 such as a 5G CN.

5G NR is a wireless communication standard for next generation mobile networks. It was developed by the 3rd Generation Partnership Project (3GPP) to provide increased capacity and faster data rates for mobile devices, as well as lower latency and more reliable communication.

The 5G NR RAN 322 is designed to operate in a number of different frequency bands, including low, mid, and high bands. It uses advanced technologies such as multiple-input multiple-output (MIMO) antennas and beamforming to increase capacity and coverage, and it utilizes new radio waveforms and modulation schemes to increase data rates and improve spectral efficiency.

5G NR also incorporates new network architecture concepts such as network slicing, which allows different parts of the network to be customized and optimized for different types of traffic and applications. This allows the 5G NR network to support a wide range of use cases, including enhanced mobile broadband, massive machine type communications, and ultra-reliable low-latency communications.

The CN 328 provides a number of distributed functions that provide various services to the network. For example, the CN 328 provides Internet (IP) connectivity for both data and voice services, and ensures the connectivity fulfills QoS requirements. The CN 328 tracks user mobility to ensure uninterrupted service, and also tracks subscriber usage for billing and charging, among other functions.

A network slice may obtain services from each of these domains. Each slice may provide a different type or quality of service that is optimized for a particular use or task. Multiple network slices may be supported by the network at once. For example, in the system shown in FIG. 3, the network supports a URLLC slice 332, an enhanced mobile broadband (eMBB) slice 334, a massive machine-type communication (mMTC) slice 336 and an artificial intelligence (AI) slice 338.

Management of the selection and operation of network slices is performed by various network functions, including a communication service management function (CSMF) 302 and a network slice management function (NSMF) 304. At the RAN level, a network slice subnet management function (NSSMF) 312 assists devices with the selection of a slice. The NSSMF may also operate to support slice selection at the transport network 326 and the core network 328 via a transport NSSMF 314 and a CN NSSMF 316.

The NSSMF is an intra-domain network slice subnet management function that provides management services for one or more network slice subnets. This domain-level management function is governed by the end-to-end NSMF 304. In this architecture, orchestrations within a slice should be implemented as virtual network function (VNF) orchestrators on one of the domains (e.g., edge cloud 324 or core network 328), managing its corresponding slice given the allocated resources by NSMF 304/NSSMF 312. However, the HRL orchestrator high-level policy should be implemented as an VNF on NSMF 304 or NSSMF 312 depending on the set of resources and if such set consists of transport or core network resources with interfaces enabling the communication between the two orchestrators. The CSMF 302 is a customer order management layer for operations support system and business support system (OSS/BSS) capability.

In an example embodiment, the HL-RLO 110 may be implemented in the NSMF 304 or the RAN NSSMF 312, while the LL-RLO 120 may be implemented on the edge cloud 324 as an AI slice management function. An AI master node 342 may be located in the edge cloud 324. However, it will be appreciated that the HL-RLO 110 and RR-RLO 120 may be located in and/or performed by different network functions/nodes of the network than those illustrated in FIG. 3.

In the illustrated example, the general objective is to maximize the AI performance (i.e., convergence time in terms of the time to reach a certain accuracy) while maintaining a required level of communication service availability (and reliability) of the URLLC service. The following description also includes mathematical models necessary for transforming high-level intents (industrial KPIs) to orchestration objectives. These objectives are subsequently employed in the definition of the HRL powered orchestrator. Finally, a description of the required communication between the orchestrator and the environment is provided.

For the high-level orchestration (network slicing for URLLC), the objective is to fulfill the various, and sometimes contradictory, requirements of different services being provided by a wireless communication system. In the following description, a wireless communication system with two slices is considered, namely, one slice for distributed AI training service and one slice for URLLC service. The objective is to minimize the distributed AI task convergence time and also fulfill the communication service reliability and availability requirements of URLLC via efficient slicing of the network resources as high-level decision variable.

For the low-level orchestration, an optimization method is provided that uses device selection to reduce/minimize the distributed AI task convergence time. The distributed AI task convergence time is a function of i) training delay, and ii) the number of iterations to reach a certain accuracy. The training delay depends on both high-level decision variables and low-level decision variables (i.e., device selection). The number of iterations required is only a function of low-level decision variable.

The present description focuses on bandwidth, transmit power, and processing capability of the network slices as the main network resources that the high level RL orchestrator (HL-RLO) controls. However, other network resources can be considered.

According to some embodiments, a HL-RLO 110 interacts with the environment and orchestrates parameters with a different temporal and behavioral abstraction (i.e., user selection to control the distributed AI performance with short time scale control, as opposed to, resource allocation to URLLC and AI slices with long time scale control.

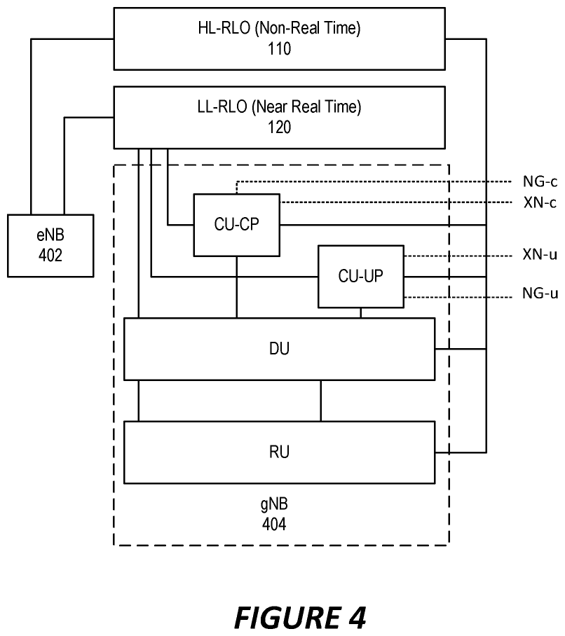

Referring to FIG. 4, some embodiments provide a HL-RLO 110 that operates in non-real time (e.g., on an interrupt or exception basis rather than at set time steps) and a LL-RLO 120 that operates in real-time or near-real time. The HL-RLO 110 and LL-RLO 120 interact with an environment 130 (FIG. 2) via components of a wireless communication network, such as an eNodeB (eNB) 402 or gNodeB (gNB) 404. The gNB may be implemented using a distributed architecture, including a control plane (CP) control unit (CU), CU-CP and a user plane (UP) CU, CU-UP, a distributed unit (DU) and a remote unit (RU).

Embodiments described herein may provide certain technical advantages. For example, the system 100 may perform near real-time control (order of 500 msec) for low level tasks (such as user selection) and non-real time control of higher level tasks, such as slice management of AI and URLLC slices.

Conventional horizontal solutions train all the decision variables using long time scale, which results in a long training time, and may lead to much higher energy consumption and network overhead due to excessive processing and communication. In contrast, a multilevel RL system as described herein may use different time scales at different levels. For example, in an example system, the bandwidth of the slices should be changed by NSMF (or NSSMF) because it is a quality of service (QoS) attribute which describes the static parameters and functional component of network slice subnet.

Operating a device selection module as an LL-RLO can massively reduce the total number of transmissions, latency, and energy consumption while achieving the same training accuracy.

Moreover, device selection will reduce the energy consumption of the AI workflow but also reduce the required resources for distributed AI service, resulting in more available resources for other services, in this case, URLLC. Moreover, since the devices are not required to train and transmit their local model at each epoch, some embodiments reduce the energy consumption on the device side.

The HL-RLO cooperates with LL-RLO to reach the target performance of multiple slices, e.g., the distributed AI and URLLC, with minimum resources, potentially resulting in more available resources for other potential services (e.g., eMBB, or mMTC), and/or ii) lower operating expenditure (OpEx).

Finally, during runtime, the cognitive layers may cooperatively aim to enforce availability preserving policies while optimizing the AI performance without any extra resources/energy consumption.

### System Model

For purposes of illustration, an industrial automation scenario is described in which a set of [symbol] :={1, . . . , B} gNBs serve a set of industrial devices. Let us define URLLC devices as devices serving URLLC service and assume a of [symbol] :={1, 2, . . . , U}, URLLC devices in the deployment. Besides, AI devices are defined as devices serving AI service and assume there exist a set of [symbol] :={1, 2, . . . , N} AI devices in the deployment. However, in real deployments and here, one industrial device might generate and receive both of the traffic types, and hence be part of both sets.

The communication system should timely and reliably deliver (i) monitoring data to the base station and (ii) computed or emergency commands to the actuators. However, application-layer availability for URLLC service is considered, implying that consecutive failures that are shorter than survival time, Tₛᵥ, do not affect the end-to-end end performance.

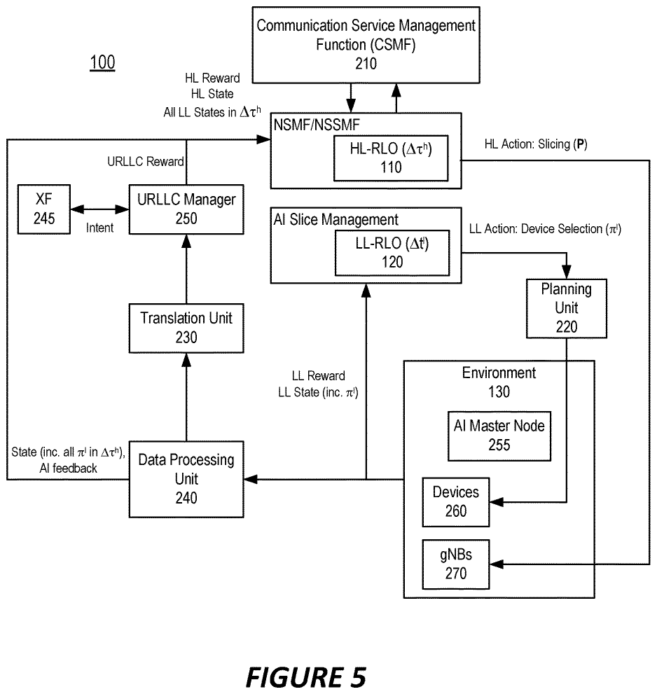

A subset of devices [symbol] _{m,k}⊆ [symbol] for ∀k∈ [symbol] are assumed, where | [symbol] _{m,k}|=mₖ, are selected to participate in a background distributed AI task. Besides, it is assumed that the AI master node 255 (described below in connection with FIG. 5) requires to receive the relevant local information from n(≤mₖ) out of these mₖ selected devices to be able to perform its algorithm update. Note that the LL-RLO 120 can select more devices than the required n participants to tackle straggling problem.

The set of resources is denoted [symbol] :={1, . . . , c, . . . , C} (e.g., bandwidth, power, processing capability, . . . ), the set of slices [symbol] :={1, . . . , v, . . . , V}, and the ratio of resources that is allocated to slice c by ρ^{v}∈[0,1]^{c}, ∀v∈ [symbol] . Then, network slice subnet management should always keep the following condition:

$${\sum }_{v = 1}^{V} {[ {ρ}^{v} ]}_{c} \leq 1 , ∀ c ∈ 𝒞 \qquad ( 4 )$$

where [ρ^{v}]_{c} denotes the element c of vector ρ^{v}, and (4) implies that the ratio of an arbitrary resource allocated to all slices should be less than (e.g., reserved for emergency service) or equal to one. Although only AI and URLLC slices are considered in this example, for generality, matrix P:=[ρ^{U}, ρ^{AI}, . . . ] is defined. Hence, in case of two slices, ρ^{U}=1−ρ^{AI}.

### Distributed AI Performance

The convergence time of the distributed AI is bounded by the communication and processing latency. The AI device selection at iteration k may be denoted by an indicator vector of [symbol] _{m,k} as πⁱ:={[π^{l}]₁, . . . , [π^{l}]_{N}}, where [π^{l}]ᵢ∈{0,1}, ∀i∈ [symbol] . The AI training delay in the master node for kth iteration (global iteration),

$${d}_{k}^{AI}$$

can be derived as:

$${d}_{k}^{AI} ( {π}^{l} , P ) = min [ {{min}_{{𝒩}_{n , k} ⊆ {𝒩}_{m , k}}}_{\vert {𝒩}_{n , k} \vert = n} ( {max}_{i ∈ {𝒩}_{n , k}} ( {d}_{k , i}^{D} + {d}_{k , i}^{pr} + {d}_{k ,}^{U} ) + {d}_{k}^{pr} ) , {T}^{timeout} ] \qquad ( 5 )$$

where

$${d}_{k , i}^{D} , {d}_{k , i}^{p r} and {d}_{k , i}^{U}$$

are the DL broadcasting latency, processing delay, and UL transmission latency for kth iteration of ith device, respectively. The quantity

$${d}_{k}^{p r}$$

is the kth iteration processing delay on the master node. Moreover, π^{l} and P represent the policy for user selection and slicing decision (e.g., bandwidth, power, and processing capability). Note that

$${d}_{k , i}^{U} and {d}_{k , i}^{D}$$

are affected π^{l} and P. In this case, assuming that the low-level orchestrator selected [symbol] _{m,k} at the current iteration (short time unit), and given the current slicing, P, the

$${d}_{k}^{AI}$$

is then from the user in [symbol] _{m,k} that the central node receives its local update the last (i.e., has the maximum aggregated communication and processing delay). Moreover, T^{timeout} prohibits the central node to wait for the local models for an infinite time.

### URLLC Performance

As equations (2) and (3) indicate, the communication service availability and reliability are measured in infinite time. Since, in closed loop control, it is required to have feedbacks on finite time, the system 100 can either approximate or estimate the communication service availability and reliability. Approximations of availability and reliability may be based on network measurements of packet error ratio and network layer crossings. However, communication service availability can also be estimated as:

$${α}_{i} \approx {\hat{α}}_{i} ( Δ t ) := \frac{1}{Δ t} {\int }_{Δ t} {Z}_{i} ( t ) dt \qquad ( 6 )$$

where Δt is a short period, e.g., the time between the two consecutive actions of the orchestrator.

The reliability unit is time and cannot be reliably estimated via small time intervals. Hence, the crossing rate from Zᵢ(t)=1 to Zᵢ(t)=0 is defined as:

$${l}_{i} := {lim}_{T \to ∞} \frac{{ϒ}_{i} ( T )}{T} \qquad ( 7 )$$

Therefore, considering equations (2), and (3), τᵢ may be calculated as:

$${τ}_{i} = \frac{{α}_{i}}{{l}_{i}} \qquad ( 8 )$$

and lᵢ can be estimated in short time steps as:

$${\hat{l}}_{i} = \frac{{ϒ}_{i} ( Δ t )}{Δ t} ) \qquad ( 9 )$$

### General Problem Formulation

The objective depends on the AI training delay and the required number of iterations to reach E-accuracy for the distributed AI task, which should be done with a minimum amount of resources. The overall cost function for N AI devices with slicing ratio P becomes:

$$J ( {π}^{l} , P ) := {\sum }_{κ = 1}^{∞} {Ω}_{κ}^{A I} ( P ) {\sum }_{k = 1}^{{K}_{κ}} {d}_{κ , k}^{A I} ( {π}^{l} , P ) {I}_{κ , k} \qquad ( 10 )$$

where J:{0,1}^{N}×[0,1]^{C}→ [symbol] (assuming that only URLLC and AI slices are present). I_{k,k} returns 1 when the distributed AI algorithm (e.g., federated learning or distributed stochastic gradient descent) has not yet reached E-accuracy at its iteration k and given the resource allocated by slicing decision k, and 0, otherwise. Such indication should come from the master node 255 (FIG. 5) that is following the distributed AI accuracy. Moreover,

$${Ω}_{κ}^{A I} ( P )$$

returns a weight representing the ratio of allocated resources to AI slice (e.g., a weighted average of resource ratios,

$${Ω}_{κ}^{AI} ( P ) := \frac{1}{C} {\sum }_{c = 1}^{C} {{w}_{c} [ {ρ}^{AI} ]}_{c} ) .$$

Note that k represents the iterations of the inner (LL) loop 125, and k represents iterations of the outer (HL) loop 115.

The general formulation for coexistence of distributed AI and URLLC for an arbitrary iteration then becomes:

$${min}_{{π}^{l} , P} J ( {π}^{l} , P ) such that :$$

$$1. {α}_{i} \geq {α}_{i}^{r e q} , ∀ i ∈ 𝒰 ,$$

$$2. {τ}_{i} \geq {τ}_{i}^{r e q} , ∀ i ∈ 𝒰 ,$$

$$3. {1}^{T} {π}^{l} \geq n ,$$

$$4. {π}^{l} ∈ {\{ 0 , 1 \}}^{N} ,$$

$${5. [ P ]}_{c , v} ∈ [ 0 , 1 ] , ∀ c ∈ 𝒞 , ∀ v ∈ V$$

$$6. {\sum }_{v = 1}^{V} {[ P ]}_{c , v} \leq 1 , ∀ c ∈ 𝒞 ,$$

$$7. {I}_{κ , k} ∈ \{ 0 , 1 \} , ∀ k ∈ [ {K}_{κ} ] , ∀ κ ∈ ℕ$$

where α₁, rᵢ,

$${α}_{i}^{r e q} , and {τ}_{i}^{r e q}$$

are respectively the communications service availability, communications service reliability, availability requirement, and reliability requirement of device i and depend on the use case this device is serving. The QoS performance is a function of P since they are impacted by the allocated resources to URLLC slice.

### Transformation to Bilevel Optimization Framework

The objective of optimization in equation (11) can be written as a bilevel optimization framework to capture the hierarchy of decision making. At the lower layer, the system 100 optimizes over π^{l} and takes one of the solutions (if the problem is not convex, there may be multiple equivalent solutions). The inner objective thus becomes:

$$J ( {π}^{l} ; P ) := {\sum }_{k = 1}^{K} {d}_{k}^{A I} ( {π}^{l} , P ) {I}_{k} \qquad ( 12 )$$

where J_{L}:{0,1}^{N}→ [symbol] and is parametrized by P. Then, the bilevel objective becomes:

$${inf}_{{π}^{l} , {ρ}^{AI}} \{ J ( {\hat{π}}^{l} , P ) : {\hat{π}}^{l} ∈ arg min {J}_{L} ( {π}^{l} \vert P ) \} \qquad ( 13 )$$

FIG. 5 illustrates the overall architecture of a system 100 according to some embodiments. There are five principal components of the system 100, including a LL-RLO 120, which is a RL-powered agent that performs device selection for distributed AI training with a short time granularity decisions (e.g., sub-second) and a HL-RLO 110, which is a RL-powered agent that allocates slice resources with a long time granularity decisions (e.g., in the order of minutes) to network slices of a wireless communication network. The system 100 further includes a data processing unit (DPU) 240, which collects the data from the environment 130, a translation unit 230 which maps the QoS related data to URLLC reliability indication, and a planning unit 220 which applies selected actions to the environment. As noted above, the CSMF 210 is a customer order management layer for operations support system and business support system (OSS/BSS) capability. The CSMF 210 may request the NSMF/NSSMF to perform resource allocation to the network slices.

As indicated in FIG. 5, the RLOs are responsible for interacting with an application/network function 245 (denoted as XF) via a translation unit 230, a user selection planning unit 220, and the environment 130. The data processing unit 240 provides communication service measurements and receives reports and status of the radio access network (RAN). The translation unit 230 derives communication service availability and reliability KPIs via approximations or estimations, as known in the art.

The environment 130 includes the RAN, industrial devices, and the distributed central node controlled by the LL-RLO 120 via the planning unit 220. In general, the planning unit 220 can perform optimizations within a slice. However, the planning unit 220 may be assumed to have no intelligence, and may simply apply actions to the environment 130. The LL-RLO 120 performs device selection policy optimization through which the convergence time of the distributed AI is minimized while fulfilling the URLLC requirement given the allocated resources to the AI slice (i.e., \hat{π}^{l}∈arg min J_{L}(π^{l}|P)). The HL-RLO 110 performs high-level optimization on the allocated resources to different slices, including AI slice, with a goal to minimize the resources allocated to the AI slice.

The objective of the HL-RLO 110 is to maximize the performance of the distributed AI while guaranteeing the reliability KPIs of the URLLC service by setting the ratio of resources that is allocated to the URLLC and AI slices (i.e., P). The observations include per-device, per-service observations (URLLC-related and AI-related measurements) and per-device, per-cell measurements. The observations from orchestrated objects are sent to the HL-RLO 110 at long steps (i.e., Δτ^{h}). Such time steps are typically long and can be either periodic or event-based. For example, a time step may whenever the performance of one service drops. 3GPP requires this time to be longer than 1 second. However, due to protocol limitations to change the resource ratios, the time step Δτ^{h} can be in the order of minutes.

When the distributed training task is required, given the current ratio of resources allocated to the AI slice, the LL-RLO 120 receives the state of each device using measurements. After receiving these observations, the LL-RLO 120 selects numbers of AI devices (via π^{l}) to run local computations and share them with an AI master node 255 using command messages. Afterward, the LL-RLO 120 receives the latency of running one iteration of distributed AI and training loss in this iteration. One time step Δt^{l} of the LL-RLO 120 takes as long as one distributed AI iteration takes. The objective of the LL-RLO 120 is to minimize this period. Hence, the statistics for the LL-RLO 120 are measured in shorter time-steps Δt^{l} than the time steps Δτ^{h} of the HL-RLO 110.

Note that AI and URLLC observations should be reported per device, per service. For example, if an arbitrary device is serving only URLLC traffic, then its reports only include URLLC related measurements.

The observations related to communications service reliability KPIs, as required by application, (e.g., estimation of device availability) as well as the AI KPIs (e.g., delay of running iterations and training loss) are processed by the data processing unit 240 and further by a URLLC manager 250 as well as the LL-RLO 110 and HL-RLO 120, which compute the reward function of the latest action.

### Deep RL-Based Orchestration

As noted above, the described example involves a CPS in which end devices are responsible for performing various functions that facilitate automated production. The communication system is responsible for the timely delivery of (i) sensor data to base stations and from there to an orchestrator, and (ii) computed or emergency tasks to the actuators. For the latter, the application layer performs the requested action upon receiving the corresponding messages.

Both DL and UL transmissions of a 5G deployment are considered with (potentially) several gNBs configured with a single/multi cell setting. Note that the assumption of separate sets for AI and URLLC devices is only for notations simplification and the union of the two sets is not necessarily empty, implying that one device could serve both AI and URLLC service.

RL is used to address the orchestration problem. An RL framework consists of (i) an RL agent, (ii) an environment which is described by a set of states, and (iii) their interactions through actions and rewards. The RL approach used in the present example will now be described.

### State Space

The state space describes the environment in which the RLO learns based on the sequence of action-reward pairs. A low-level and high-level step period (Δt^{l} and Δτ^{h}, respectively) are defined as the time periods in which the measurement data is collected given actions from the LL-RLO 120 and HL-RLO 110, respectively. Since the iteration numbers of the HL-RLO 110 and LL-RLO 120 vary, their iteration number is denoted by k and k, respectively, and their state at an arbitrary iteration by

$${s}_{κ}^{h} and {s}_{k}^{l} ,$$

respectively. The reported state at an arbitrary iteration for both orchestrators is described below.

### HL-RLO State Space

$${s}_{κ}^{h}$$

The HL-RLO State Space

$${s}_{κ}^{h}$$

includes URLLC related variables, such as implicit QoS variables, explicit QoS variables, distributed AI variables and cell-related information. Implicit QoS variables include variables relating to communications service availability and reliability that are a function of packet error ratio, mean downtime on network layer, and survival time for the specific use case. Hence, the packet error ratio and mean downtime of each user in the state space may be used as implicit QoS variables. Note that survival time is a setting that does not change, and therefore, it is not necessary to be added.

Explicit QoS variables are measurement logs that explicitly impact the QoS of URLLC. Such measurements include, but are not limited to: i) the cell that each URLLC device is associated with, ii) buffer size at the end of step, iii) statistics of received SINR or other indicators of interference (e.g., 99th percentile, 95th percentile, median, mean) of each device, (iv) end-to-end delay statistics (e.g., 99th percentile, 95th percentile, median, mean), and v) path gain statistics (e.g., 99th percentile, 95th percentile, median, mean). In fact, utilizing such percentiles is well motivated by URLLC extreme availability/reliability performance, which, under proper system design, is affected by the tail of delay and SINR distributions. The SINR is a function of various parameters such as interference caused by other URLLC and AI devices. The buffer size depends on the traffic arrival, queuing mechanism, packet size, code rate, and the setting for the number of diversity transmissions.

Distributed AI variables include measurements that impact AI service performance. Such measurements include but are not limited to: i) the end-to-end delay of transmitting the global/local models to/from each AI device, ii) the SINR statistics of each AI device (e.g., 95th percentile, median, mean, and 5th percentile), and iii) all the device selections (π^{l}) by LL-RLO in the last

$${Δt}_{κ}^{h} ,$$

if any.

Cell level information is per service and includes the resource utilization of each service (URLLC and AI in this case).

### LL-RLO State Space,

$${s}_{k}^{l}$$

The LL-RLO state at each iteration includes only distributed AI variables which include (but are not limited to): i) the end-to-end delay of transmitting the global/local models to/from each AI device, ii) the drift of each local model with respect to the global model, iii) the last time this AI device was selected in the training, and iv) the SINR statistics of each AI device (e.g., 95th percentile, median, mean, and 5th percentile).

### Action Space

The action space is the set of decision parameters through which the RL agent interacts with the environment. The action of the HL-RLO 110 at each iteration,

$${a}_{κ}^{h} ,$$

is a vector indicating the ratio of resources that should be allocated to each service (v), and for each resource c is [P]_{c,v}∈[0, 1]. Hence, for all of the controlled resources, the actions space becomes [symbol] ^{h}:=[0,1]^{V}, where V is the number of resources that the HL-RLO 110 has the control to slice. Assuming that there exist only AI and URLLC services in the cyber-physical production system, then the HL-RLO 110 should only decide an allocation for one slice (e.g., the AI slice). Then the allocation ratio, for the URLLC slice for each resource c and Kth iteration becomes:

$$1 - reserved ratio - {[ {ρ}_{κ}^{A I} ]}_{c} .$$

Note that, in this case

$${ρ}_{κ}^{AI} ,$$

as the original optimization variable and

$${a}_{κ}^{h} ,$$

as the action of LL-RLO 120 are equivalent. The action of LL-RLO 120 is the device selection policy (π^{l}) which is a binary vector indicating if an AI device should be selected or not in the next round of training, and hence its actions space becomes [symbol] ^{l}:={0,1}^{N}, where N is the total number of AI devices that the LL-RLO 120 can control. However, for performing seamless AI training, the LL-RLO 120 should be required to select at least n AI devices. Hence, to mask out selections that do not follow this condition,

$${a}_{k}^{l}$$

is defined as a continuous vector where each element represents the action for an AI device

$$( i . e . , {a}_{k}^{l} ∈ {[ 0 , 1 ]}^{N} ) .$$

Then, the mapping from

$${a}_{k}^{l} to {π}_{k}^{l}$$

is determined by:

$${π}_{k}^{l} := \{ \begin{matrix}𝕝 \{ {a}_{k}^{l} ≽ 0 \} & if {1}^{T} 𝕝 \{ {a}_{k}^{l} ≽ 0 \} \geq n , \\ 𝕝 \{ {a}_{k}^{l} ≽ {a}_{k , ( n )}^{l} 1 \} & otherwise\end{matrix} \qquad ( 14 )$$

where 1 and 0 denote all-one and all-zero vectors, respectively, ∥{·} is an element-wise indicator function returning a vector in which an element takes the value 1 if the condition for that element is met. The curled inequality (≥) represents element-wise inequality. Hence, the ith element of

$$𝕝 \{ {a}_{k}^{l} ≽ 0 \} is 1 {if [ {a}_{k}^{l} ]}_{i} \geq 0 .$$

### Besides,

$${a}_{k , ( n )}^{l}$$

is the nth largest element in vector

$${a}_{k}^{l} .$$

### The Reward, Goal and Constraint Functions

The objective of the reward, r_{k,k}, function, as the feedback for the LL-RLO 120, is to minimize the convergence time of the distributed AI task, and is defined as:

$${r}_{κ , k} := \frac{{T}^{t i m e o u t} - {d}_{κ , k}^{A I} ( {π}^{l} , P )}{{T}^{t i m e o u t}} \qquad ( 15 )$$

where

$${d}_{κ , k}^{A I}$$

is the AI training delay achieved in kth iteration of the LL-RLO 120 and Kth iteration of HL-RLO 110.

In general, the goal of the HL-RLO 110 goal is to fulfill the requirements of different slices with minimum resources, and hence, its goal is defined as:

$${g}_{κ} := {\sum }_{v = 1}^{V} {ζ}_{v} {r}^{v} {Ω}_{κ}^{v} ( P ) , ∀ v ∈ V \qquad ( 16 )$$

where ζᵥ is a weight characterizing the relative importance of different slices and

$${\sum }_{v = 1}^{V} {ζ}_{V} = 1 ,$$

r^{v} is the high-level reward for slice v, and Ψₖ(ρ^{v}) is a function representing the ratio of resources allocated to slice v. Then, for the coexistence problem, with AI and URLLC slices, the goal becomes:

$${g}_{κ} = {ζ}_{AI} {μ}_{d} {Ω}_{κ}^{AI} ( P ) + {ζ}_{U} exp ( v min \{ {min}_{i ∈ 𝒰} ( {\hat{α}}_{i} ( Δ {t}_{k}^{h} ) - {a}_{i}^{req} ) , 0 \} ) {Ω}_{κ}^{U} ( P ) \qquad ( 17 )$$

where μ_{d} is the mean of r_{k,k} samples for ∀k∈{1, 2, . . . , Kₖ}. Note that gₖ is measured on a much higher time scale than r_{k,k} (i.e., Δτ^{h}>>Δτ^{l}). The URLLC reward is negative for those URLLC devices that did not meet their corresponding availability requirement within

$$Δ {t}_{κ}^{h} .$$

Therefore, the function design requires the HL-RLO 110 to maximize the availability of the worst URLLC device among those that do not fulfill their availability requirements. The quantity v is a design factor that determines the sensitivity of the URLLC use case to which URLLC devices are serving.

The slicing policy π^{h} gets the full URLLC reward when all of the devices fulfill their availability requirements. For the distributed AI service reward, the shorter μ_{d} is, the larger the π^{l}'s reward becomes. Moreover, to minimize the tail of the per-device availability distribution and the average training delay, the URLLC reward decreases exponentially while the reduction in distributed AI reward is linear. Unlike AI service in which the focus is on average statistics, the focus in URLLC service is to fulfill the strict requirements.

Even though τᵢ in equation (3) is suggested as a measure of communication service reliability, this metric may be misleading in the context of telecommunications, especially when the target reliability values are expressed in long periods of time, e.g., years. Such a metric is not a conventional measure of the reliability of communication services, and this is not added in equation (17). However, if required, it can be added using its approximation or estimation in equation (9). In such case, equation (8) can be used to derive crossing rate requirement

$$( i . e . , {l}_{i}^{req} := \frac{{α}_{i}^{req}}{{τ}_{i}^{req}} ) ,$$

resulting in high-level URLLC slice reward:

$${r}^{U} = exp ( v min \{ {min}_{i ∈ 𝒰} ( {\hat{α}}_{i} ( Δ {t}_{κ}^{h} ) - {a}_{i}^{reg} , {l}_{i}^{reg} - {\hat{l}}_{i} ( Δ {t}_{κ}^{h} ) ) , 0 \} ) \qquad ( 18 )$$

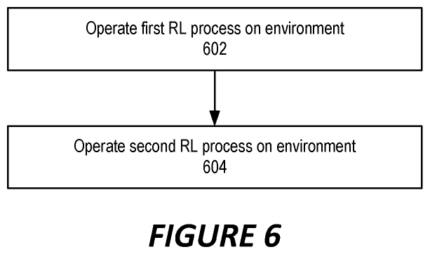

FIG. 6 illustrates operations of a multilevel RL system 100 according to some embodiments. As shown therein, the method includes operating a first RL process on an environment (block 602) by iteratively taking a high-level, HL, action on the environment and, in response to the HL action, observing a HL state of the environment and receiving a HL reward. The method further includes operating a second RL process on the environment (block 604) by iteratively taking a low-level, LL, action on the environment and, in response to the LL action, observing a LL state of the environment and receiving a LL reward, wherein the LL state is affected by the HL action. Operating the second RL process comprises generating the LL action to be performed on the environment according to a LL policy based on the LL state and the LL reward. Operating the first RL process comprises generating the HL action to be performed on the environment according to a HL policy based on the HL state and the HL reward and based on the LL state and a plurality of LL rewards.

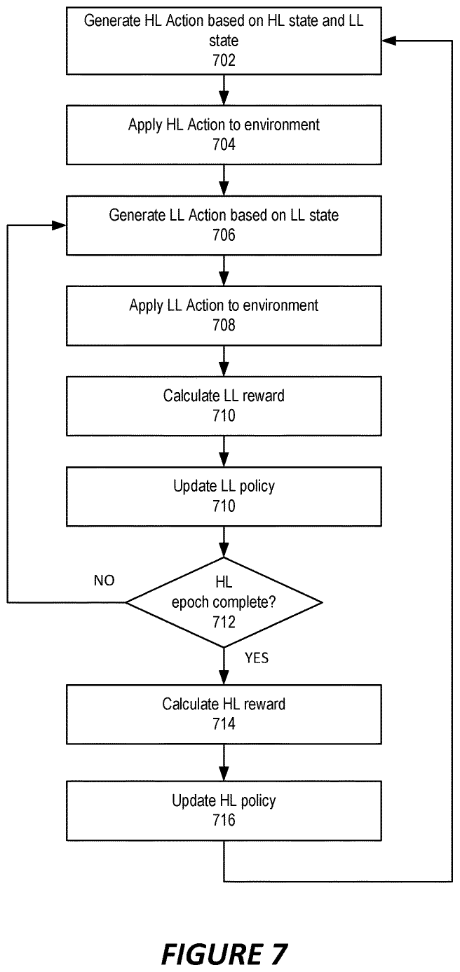

Operations of the system 100 are shown in more detail in FIG. 7. Referring to FIGS. 5 and 7, a HL-RLO 110 generates a HL action based on a HL state and a LL state (block 702). The HL-RLO 110 applies the HL action to the environment at block 704. A LL-RLO 120 generates a LL action based on the LL state (block 706) and applies the LL action to the environment at block 708. The LL-RLO 110 calculates a LL reward based on the LL action at block 710 and updates the LL policy π^{l} based on the reward (block 710).

At block 712, the system determines if a HL epoch is complete (i.e., a time period Δτ^{h} has elapsed), and if not, operations return to block 706 for another iteration of the LL loop.

If an HL epoch is complete, the HL-RLO 110 calculates a HL reward (block 714) and updates the HL policy π^{h} based on the reward (block 716). Operations then return to block 702.

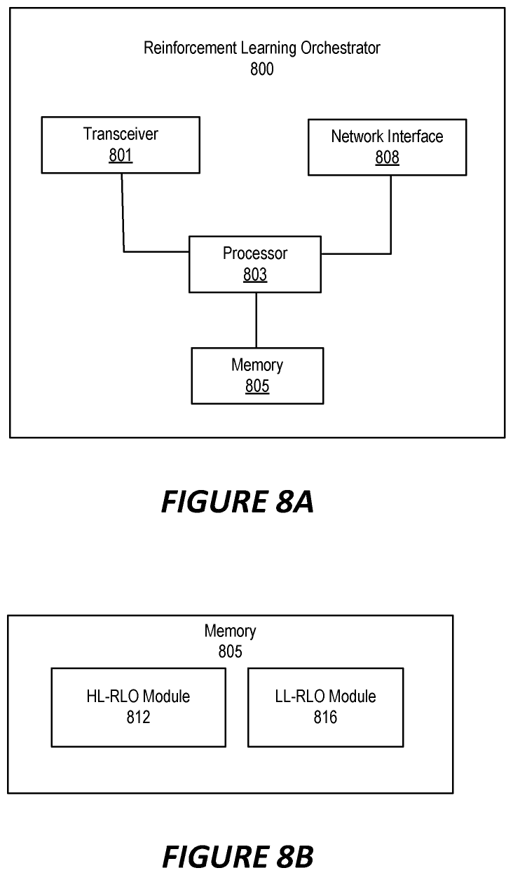

FIG. 8A is a block diagram of a reinforcement learning orchestrator 800 that may be used to implement the HL-RLO 110 and/or LL-RLO 120 illustrated in FIG. 5. The orchestrator 800 may be provided by, e.g., a device in the cloud running software on cloud computing hardware; or a software function/service governing or controlling a wireless communication network. That is, the device may be implemented as part of a communications system, or on a device as a separate functionality/service hosted in the cloud. The device also may be provided as a standalone software for managing a wireless communication network; and the device may be in a deployment that may include virtual or cloud-based network functions (VNFs or CNFs) and even physical network functions (PNFs). The cloud may be public, private (e.g., on premises or hosted), or hybrid.

As shown in FIG. 8A, the orchestrator 800 may include transceiver circuitry 801 (e.g., RF transceiver circuitry) including a transmitter and a receiver configured to provide uplink and downlink radio communications with devices (e.g., a controller for automatic execution of actuations). The orchestrator 800 may include network interface circuitry 808 (also referred to as a network interface) configured to provide communications with other devices (e.g., a controller for automatic execution of an actuation). The orchestrator 800 may also include processing circuitry 803 (also referred to as a processor) coupled to the transceiver circuitry, memory circuitry 805 (also referred to as memory) coupled to the processing circuitry.

As discussed herein, operations of the orchestrator 800 may be performed by processing circuitry 803, network interface 808, and/or transceiver 801. For example, processing circuitry 803 may control the orchestrator 800 to perform operations according to embodiments disclosed herein. Processing circuitry 803 also may control transceiver 801 to transmit communications through transceiver 801 over a radio interface to one or more devices and/or to receive communications through transceiver 801 from one or more devices over a radio interface. Similarly, processing circuitry 803 may control network interface 808 to transmit communications through network interface 808 to one or more devices and/or to receive communications through network interface from one or more devices. Moreover, modules may be stored in memory 805, and these modules may provide instructions so that when instructions of a module are executed by processing circuitry 803, processing circuitry 903 performs respective operations (e.g., operations discussed below with respect to example embodiments relating to devices). According to some embodiments, orchestrator 800 and/or an element(s)/function(s) thereof may be embodied as a virtual device/devices and/or a virtual machine/machines.

According to some other embodiments, an orchestrator 800 may be implemented without a transceiver. In such embodiments, transmission to a wireless device may be initiated by the orchestrator 800 so that transmission to the wireless device is provided through a device including a transceiver (e.g., through a base-station). According to embodiments where the device includes a transceiver, initiating transmission may include transmitting through the transceiver.

FIG. 8B illustrates various functional modules stored in the memory 805 of the orchestrator 800. In particular, the memory 805 may include a HL-RLO module 812 and/or a LL-RLO module 816 to allow the orchestrator 800 to perform the operations of an HL-RLO 110 and/or a LL-RLO 120 as described above. Other modules may also be provided in the memory 905 to effect the operations described above.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A multilevel reinforcement learning system, comprising:
a first reinforcement learning orchestrator, RLO, that operates a first reinforcement learning, RL, process on an environment; and
a second RLO that operates a second RL process on the environment;
wherein the second RLO generates a low level, LL, action to be performed on the environment according to a LL policy based on a LL state and a LL reward that are observed from the environment; and
the first RLO generates a high level, HL, action to be performed on the environment according to a HL policy based on a HL state and a HL reward that are observed from the environment and based on the LL state and a plurality of LL rewards.

2. The multilevel reinforcement learning system of claim 1, wherein the first RLO receives the HL state and the HL reward and generates HL actions at a first frequency, and the second RLO receives the LL state and the LL reward and generates LL actions at a second frequency, wherein the second frequency is different from the first frequency.

3. The multilevel reinforcement learning system of claim 2, wherein the second frequency is higher than the first frequency.

4. The multilevel reinforcement learning system of claim 1, wherein the LL action generated by the second RLO is transmitted to an agent in the environment that is to perform the LL action, and wherein operation of the agent in the environment is affected by the HL action generated by the first RLO.

5. The multilevel reinforcement learning system of claim 4, wherein the agent comprises a network device in a wireless communication network.

6. The multilevel reinforcement learning system of claim 1, wherein the environment comprises a wireless communication network.

7. The multilevel reinforcement learning system of claim 1, wherein the HL policy comprises a policy for allocating resources to a plurality of network slices in a wireless communication system, and wherein the LL policy comprises a policy for selecting network devices for performing a distributed computing function, wherein the network devices utilize services of one of the plurality of network slices.

8. The multilevel reinforcement learning system of claim 7, wherein the HL action comprises a selection of network resources to be allocated to the plurality of network slices.

9. The multilevel reinforcement learning system of claim 7, wherein the LL action comprises a selection of network devices to participate in the distributed computing function.

10. The multilevel reinforcement learning system of claim 7, wherein the one of the plurality of network slices utilized by the network devices supports ultra-reliable low latency communications, URLLC.

11. The multilevel reinforcement learning system of claim 7, wherein the HL reward is based on one or more quality of service, QoS, variables associated with the plurality of network slices, and wherein the LL reward is based on a convergence time and accuracy of the distributed computing function.

12. The multilevel reinforcement learning system of claim 7, wherein the first RLO has a goal of maximizing a goal function that measures performance of all of the plurality of network slices.

13. The multilevel reinforcement learning system of claim 12, wherein the goal function has a form:
$${g}_{κ} := {\sum }_{v = 1}^{V} {ζ}_{v} {r}^{v} {Ω}_{κ}^{v} ( P ) , ∀ v ∈ V$$
where V is a number of network slices, ζᵥ is a weight characterizing a relative importance of a network slice v, r^{v} is a high-level reward for network slice v, Ω^{v}ₖ(P) is a function representing a ratio of resources allocated to network slice v according to a resource allocation matrix P.

14. The multilevel reinforcement learning system of claim 13, wherein the high-level reward for the network slice used by the network devices that perform the distributed computing function during a training epoch of the first RLO is calculated based on a plurality of low-level rewards received by the second RLO during the training epoch.

15. The multilevel reinforcement learning system of claim 14, wherein the high-level reward for the network slice used by the network devices that perform the distributed computing function during the training epoch is calculated as a function of the low-level rewards received by the second RLO during the training epoch.

16. The multilevel reinforcement learning system of claim 14, wherein the high-level reward for the network slice used by the network devices that perform the distributed computing function during the training epoch is calculated as an average of the low-level rewards received by the second RLO during the training epoch.

17. The multilevel reinforcement learning system of claim 7, wherein the distributed computing function comprises a distributed machine learning function.

18. A computer-implemented method of performing multilevel reinforcement learning, comprising:
operating a first reinforcement learning, RL, process on an environment by iteratively taking a high-level, HL, action on the environment and, in response to the HL action, observing a HL state of the environment and receiving a HL reward; and
operating a second RL process on the environment by iteratively taking a low-level, LL, action on the environment and, in response to the LL action, observing a LL state of the environment and receiving a LL reward, wherein the LL state is affected by the HL action;
wherein operating the second RL process comprises generating the LL action to be performed on the environment according to a LL policy based on the LL state and the LL reward; and
wherein operating the first RL process comprises generating the HL action to be performed on the environment according to a HL policy based on the HL state and the HL reward and based on the LL state and a plurality of LL rewards.

19. The method of claim 18, wherein the HL state and the HL reward are received and the HL action is generated at a first frequency, and the LL state and the LL reward are received and the LL action is generated at a second frequency, wherein the second frequency is different from the first frequency.

20. The method of claim 19, wherein the second frequency is higher than the first frequency.

21-36. (canceled)
